(19) United States
(12) Patent Application Publication
(10) Pub. No.: US 2023/0192077 A1
(43) Pub. Date: Jun. 22, 2023

(54) ADJUSTMENT OF OBJECT TRAJECTORY UNCERTAINTY BY AN AUTONOMOUS VEHICLE

(71) Applicant: GM Cruise Holdings LLC, San Francisco, CA (US)

(72) Inventors: Chingiz Bagatur Ogly Tairbekov, Alexandria, VA (US); Daniel Alves Paladim, San Francisco, CA (US)

(21) Appl. No.: 17/553,617

(22) Filed: Dec. 16, 2021

(51) Int. Cl. B60W 30/095; B60W 60/00; B60W 50/00; G06V 20/58; G06N 20/00

(52) U.S. Cl. CPC B60W 30/0956; B60W 50/0097; B60W 60/0011; B60W 60/00274; G06N 20/00; G06V 20/58; B60W 2554/4041; B60W 2554/4044; B60W 2554/4046

(57) ABSTRACT

Disclosed are systems and techniques for managing an autonomous vehicle (AV). In some aspects, an AV may predict a first predicted position of an object perceived by one or more sensors of the autonomous vehicle, wherein the first predicted position of the object is associated with an uncertainty metric. The AV may determine that a first error between a first actual position of the object and the first predicted position of the object is greater than the uncertainty metric. The AV may increase the uncertainty metric corresponding to a second predicted position of the object based on the first error to result in a revised uncertainty metric. The AV may provide the revised uncertainty metric to a planning stack for maneuvering the AV.

### FIELD OF THE DISCLOSURE

Aspects of the present disclosure generally relate to autonomous vehicles. In some implementations, examples are described for adjusting an uncertainty metric associated with the predicted trajectory of an object perceived by an autonomous vehicle.

### BACKGROUND

An autonomous vehicle is a motorized vehicle that can navigate without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

Autonomous vehicles can be implemented by companies to provide self-driving car services for the public, such as taxi or ride-hailing (e.g., ride-sharing) services. The self-driving car services can increase transportation options and provide a flexible and convenient way to transport users between locations. A user will typically request a ride through an application provided by the self-driving car service to use a self-driving car service. When requesting the ride, the user can designate a pick-up and drop-off location, which the self-driving car service can use to identify the route of the user and select a nearby autonomous vehicle that is available to provide the requested ride to the user. In some cases, an autonomous vehicle may implement one or more machine learning algorithms for perceiving the environment, predicting the future trajectory of objects in the environment, and/or operating the autonomous vehicle.

### BRIEF DESCRIPTION OF THE DRAWINGS

FIG. 1 illustrates an example of a system for managing one or more Autonomous Vehicles (AVs), in accordance with some aspects of the present technology.

FIGS. 2A, 2B, and 2C illustrate examples of an environment for adjusting an uncertainty metric associated with the predicted trajectory of an object, in accordance with some aspects of the present technology.

FIGS. 3A and 3B illustrate examples of a graph of an uncertainty distribution associated with the predicted location of an object, in accordance with some aspects of the present technology.

FIG. 4 illustrates an example of a method for adjusting an uncertainty metric associated with the predicted trajectory of an object, in accordance with some aspects of the present technology.

FIG. 5 illustrates an example of a system for implementing certain aspects of the present technology.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

An autonomous vehicle can support different modes of operation with varying degrees of autonomy. In some cases, an autonomous vehicle may be configured to operate in a driverless autonomous driving mode in which the autonomous vehicle may operate without a driver or technician providing local human supervision. While operating in a driverless autonomous driving mode, an autonomous vehicle may utilize perception software (e.g., a perception stack) together with one or more sensors to detect and classify objects within its environment. In some cases, an autonomous vehicle can utilize prediction software (e.g., a prediction stack) to predict the future trajectory of objects in the environment (e.g., based on data received from the perception stack). In some examples, an autonomous vehicle can utilize planning software (e.g., a planning stack) to operate and/or maneuver the autonomous vehicle (e.g., based on data received from the prediction stack).

In some cases, an autonomous vehicle may encounter an object that moves unpredictably. For example, a pedestrian that drops a personal item may suddenly stop walking in order to pick up the item. In another example, a cyclist that suffers a flat tire may suddenly swerve or fall down. Such an aleatoric uncertainty in the decision process of an object (e.g., pedestrian) can hinder the prediction of the object’s future trajectory and the operation of the autonomous vehicle.

The disclosed technologies address a need in the art for adjusting an uncertainty metric associated with the predicted trajectory of an object by an autonomous vehicle. In some examples, an autonomous vehicle can predict one or more predicted locations of an object based on data received from perception software (e.g., coupled to one or more sensors) of the autonomous vehicle. In some cases, each of the predicted locations can be associated with an uncertainty metric that may represent a range descriptive of an area of probabilistic locations around the predicted location in which it is deemed probable for the object to be located at the time corresponding to the predicted location.

In some aspects, the autonomous vehicle may determine that an error between the predicted location and the actual location is greater than the uncertainty metric associated with the predicted location. In response, the autonomous vehicle may increase the uncertainty metric corresponding to one or more future predicted locations resulting in a revised uncertainty metric. In some cases, the revised uncertainty metric can compensate for the error (e.g., the error can be included within an expected error distribution or within a particular quantile of the expected error distribution).

In some examples, the revised uncertainty metric can be provided to planning software for maneuvering the autonomous vehicle. In some aspects, planning software (e.g., the planning stack) can use the revised uncertainty metric to adjust the trajectory of the autonomous vehicle. For example, the planning software may use an alternative route that avoids the object associated with the revised uncertainty metric. In some cases, the planning software can use the revised uncertainty metric to revise vehicle kinematics, adjust control of vehicle actuators, delay a time period before assertion, and/or perform any other function or maneuver associated with control of the vehicle. For example, the planning software may cause the vehicle to stop if the revised uncertainty metric associated with a pedestrian is sufficiently large.

In some examples, the present technology can be implemented independent of a machine learning model (e.g., without assumptions relating to the structure of a model and/or the value of its embeddings). In some cases, the present technology can be implemented without defining an anomaly in terms of input (e.g., sensor data) to a machine learning model. For example, the error in the prediction of a future position can be determined irrespective of an input distribution or particular weights in a model. In some aspects, the present technology can be used to recover from larger errors in prediction of future locations by applying the uncertainty adjustment.

In some aspects, the uncertainty adjustment (e.g., revising or increasing the uncertainty metric) can be implemented while the autonomous vehicle is on the road (e.g., for each prediction) without retraining the machine learning model. In some examples, the present technology can be used to capture an idiosyncratic error of the model and input pair. In some cases, the present technology may be used to adjust a machine learning model to modes that were not previously encountered (e.g., not part of training data). In some aspects, the present technology can be used to manage a failed prediction by using the normal operation of the downstream system (e.g., the planning stack will handle using revised uncertainty metric).

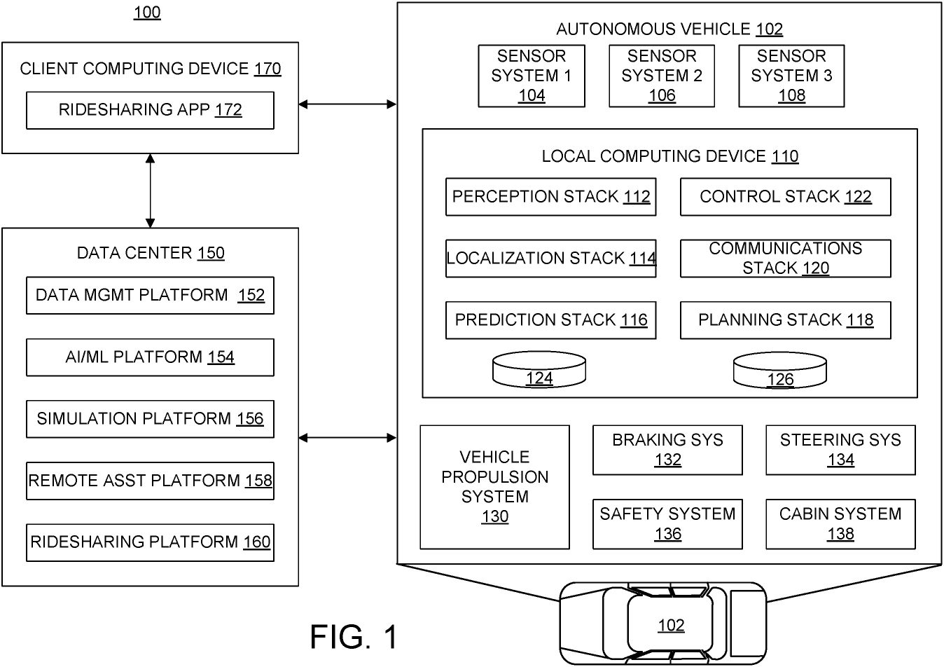

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematics of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112 - 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

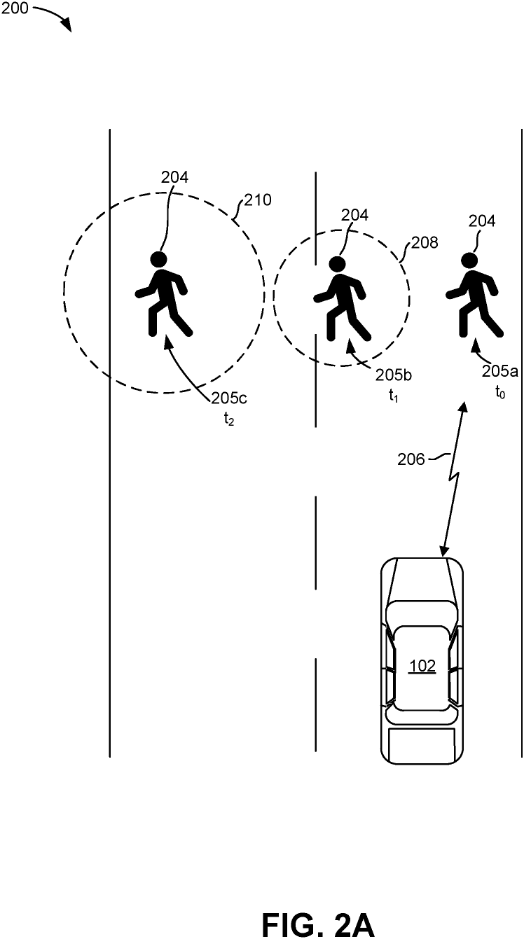

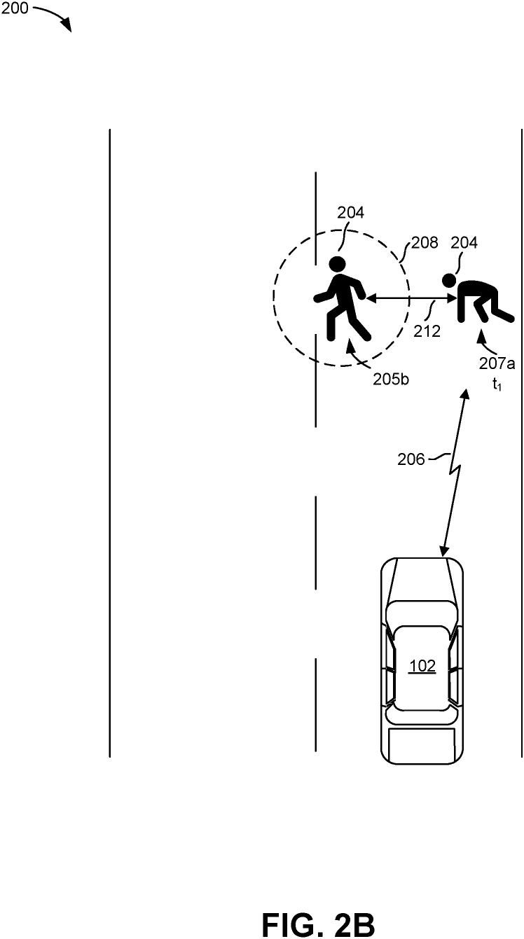

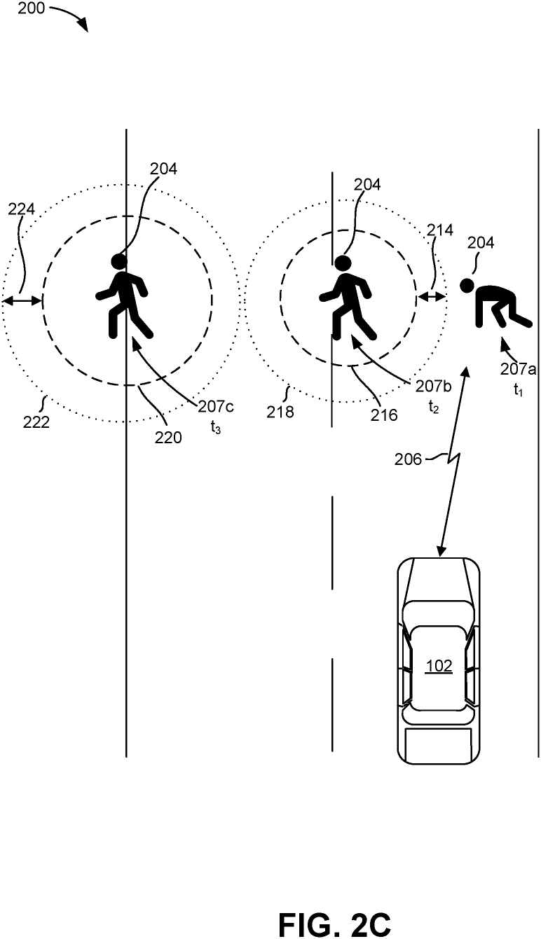

FIG. 2A illustrates an example environment 200 that includes autonomous vehicle (AV) 102. As noted above, AV 102 can use the perception stack 112 to detect and classify objects within environment 200 and determine their current locations, speeds, directions, etc. In some examples, objects detected by the perception stack 112 can include pedestrians, animals, cyclists, vehicles, structures, signs, and/or any other obj ect that may be in environment 200 with AV 102. For instance, the sensor systems 104-108 of AV 102 can transmit and receive signals (e.g., signal 206) that can be used by the perception stack 112 to detect pedestrian 204 at position 205a in environment 200.

In some embodiments, AV 102 can include a prediction stack 116 that can receive information associated with objects detected by the perception stack 112. For example, the prediction stack 116 can receive information indicating that pedestrian 204 is currently located (e.g., time t₀) at position 205a. In some aspects, the prediction stack 116 can use the information received from the perception stack 112 to predict one or more future paths (e.g., a predicted path or a predicted trajectory) for pedestrian 204. In some cases, a predicted path for pedestrian 204 can include one or more predicted future locations corresponding to one or more future time intervals (e.g., a time series of records). In some aspects, the predicted path can include predicted future locations corresponding to half second steps. For example, prediction stack 116 can predict that pedestrian 204 will be at location 205b at time t₁ (e.g., 0.5 s) and that pedestrian 204 will be at location 205c at time t₂ (e.g., 1 s).

In some examples, each predicted future location in the predicted path of an object can correspond to a position on a plane (e.g., x, y, z coordinates). In some cases, each predicted future location in a predicted path of an object can be associated with a direction or heading for the object (e.g., yaw angle). In some cases, the position of the track of interest of an object at time t can be represented by a vector xt. In some aspects, the prediction stack 116 can determine predicted position µ and uncertainty (e.g., covariance matrix) Σ for nΔt seconds as per equation (1), in which the super-index can denote a time the prediction was made and the sub-index can denote the future time, as follows:

$$\left({μ}_{t + Δ t}^{t} , {\sum }_{t + Δ t}^{t}\right) , \left({μ}_{t + 2 Δ t}^{t} , {\sum }_{t + 2 Δ t}^{t}\right) , … , \left({μ}_{t + n Δ t}^{t} , {\sum }_{t + n Δ t}^{t}\right)$$

In some embodiments, each predicted location in the predicted path of an object can be associated with one or more uncertainty metrics. In some aspects, the one or more uncertainty metrics can include a variance in a direction of movement for the object. For example, the one or more uncertainty metrics can include four variances representing the uncertainty in each of the four directions (e.g., up, down, left, and right).

In some aspects, an uncertainty metric can be used to represent a range descriptive of an area of probabilistic locations around a future location in which it is deemed probable for an object to be located at the time corresponding to the predicted future location. For example, predicted future location 205b at time t₁ for pedestrian 204 can be associated with one or more uncertainty metrics corresponding to uncertainty area 208. In some aspects, uncertainty area 208 can represent the area in which pedestrian 204 is expected to be at time t₁. In another example, predicted future location 205c at time t₂ for pedestrian 204 can be associated with one or more uncertainty metrics corresponding to uncertainty area 210. In some cases, uncertainty area 210 can represent the area in which pedestrian 204 is expected to be at time t₂. Although uncertainty areas 208 and 210 are illustrated as having a circular shape, those skilled in the art will recognize that the present technology is not limited to a particular geometric shape. For example, uncertainty metrics corresponding to variances in directions of movement may have different values that can result in different shapes for an uncertainty area. In some examples, a tracked object (e.g., pedestrian 204) may not be located in the center of an uncertainty area.

In some embodiments, an uncertainty metric can be determined or calculated using a machine learning algorithm. In some cases, the machine learning model can be fit on a set of input features ‘X’ to the future position ‘Y.’ In some aspects, the loss function can be based on the Euclidean distance (e.g., the L2 norm). In some examples, the error can be calculated as follows:

$$e r r o r = {\left({Y}_{o b s e r v e d} - {Y}_{p r e d i c t e d}\right)}^{2}$$

In some embodiments, an error (e) can be a function of past predictions and realized and/or observed track positions. In some aspects, if the error quantity e exceeds a threshold value, prediction stack 116 can adjust one or more uncertainty metrics corresponding to future predictions (e.g., adjust uncertainty metric such that e does not exceed threshold). For example, prediction stack 116 may generate a trajectory prediction at time t and may adjust the uncertainty metric associated with the next predicted location (e.g., due to an error e that exceeds a threshold). In some cases, the prediction stack 116 may determine the error e at a current time t using a prior prediction t - Δt. In some embodiments, the error e may be determined according to equation (3), in which xt corresponds to a realized position at current time,

$${μ}_{t}^{t - Δ t} \text{corresponds}$$

to the position predicted by the model, and

$${\sum }_{t}^{t - Δ t} \text{corresponds}$$

to the covariance predicted by the model, as follows:

$$e = {\left[{x}_{t} - {μ}_{t}^{t - Δ t}\right]}^{T} {\left({\sum }_{t}^{t - Δ t}\right)}^{- 1} \left[{x}_{t} - {μ}_{t}^{t - Δ t}\right]$$

In some cases, the error or uncertainty metric can follow a chi-square distribution with two degrees of freedom (e.g.,

$$\left({χ}_{2}^{2}\right) .$$

In some embodiments, by specifying a quantile-threshold (e.g., 0.99), the uncertainty metric can be adjusted per the following equation:

$$P \left({χ}_{2}^{2} < e\right) > 0.99$$

For instance, if the probability of observing an event more extreme than e is less than 1%, the uncertainty metric can be increased. In some cases, the covariance can be scaled by a factor ∝ such that

$$P \left({χ}_{2}^{2} < \frac{e}{∝}\right) = 0.99$$

(e.g., makes the probability of a more extreme event equal to 1%). In some cases, a Gaussian distribution may be used. In some examples, an empirical distribution function can be used (e.g., e is not chi-square distributed). In some aspects, the empirical distribution may be constructed by collecting sample errors that may be used to estimate quantiles. In some cases, the empirical distribution function can correspond to a histogram.

FIG. 2B illustrates environment 200 that includes AV 102. In some cases, the environment 200 in FIG. 2B may follow sequentially from that illustrated in FIG. 2A. In some aspects, pedestrian 204 may have discontinued walking along the prior trajectory. For example, pedestrian 204 may have tripped and fallen. In another example, pedestrian 204 may have dropped a personal belonging such as a cellular phone or a file of papers. In some cases, pedestrian 204 may stop and attempt to retrieve the personal item(s). In some examples, pedestrian 204 may run erratically to collect items that are blowing in the wind. In some cases, pedestrian 204 may continue walking because the item that was dropped is of no value. In some examples, pedestrian 204 may walk in an opposite direction after retrieving the item.

In some embodiments, the prediction stack 116 of AV 102 can receive information (e.g., from perception stack 112) indicating that pedestrian 204 is located at position 207a at time t₁. In some examples, the prediction stack 116 can calculate an error 212 between the actual position 207a of pedestrian 204 at time t₁ and the prior predicted position 205b at time t₁. In some aspects, the prediction stack 116 can determine that the error 212 between the actual position 207a of pedestrian 204 at time t₁ is outside of the uncertainty area 208 associated with predicted position 205b.

FIG. 2C illustrates environment 200 that includes AV 102. In some aspects, the prediction stack 116 of AV 102 can use the information received from the perception stack 112 to determine a new predicted path for pedestrian 204. For example, prediction stack 116 can predict that pedestrian 204 will be at location 207b at time t₂ and that pedestrian 204 will be at location 207c at time t₃.

In some embodiments, the prediction stack 116 can use error 212 (e.g., error associated with a prior prediction) to adjust or revise one or more uncertainty metrics associated with future predicted locations. For example, predicted future location 207b at time t₂ for pedestrian 204 can be associated with a revised uncertainty metric corresponding to revised uncertainty area 218 (e.g., uncertainty area 216 increased by factor 214). In another example, predicted future location 207c at time t₃ for pedestrian 204 can be associated with a revised uncertainty metric corresponding to revised uncertainty area 222 (e.g., uncertainty area 220 increased by factor 224). In some examples, each subsequent predicted trajectory may include one or more predicted positions that overlap with one or more predicted positions in a prior predicted trajectory. For instance, the prediction stack 116 can make time overlapping predictions (e.g., every 100 ms). In some aspects, error 212 can be used to adjust the uncertainty metric associated with a plurality of predicted positions.

In some cases, the factor (e.g., factor 214) for adjusting an uncertainty parameter can be selected to fit error 212 within an error distribution and/or within a particular quantile of an error distribution. For example, the variance of an uncertainty parameter (e.g., directional variance) can be adjusted to fit within 0.99 percentile by using a factor α as follows:

$$P \left({χ}_{2}^{2} < \frac{e}{∝}\right) = 0.99$$

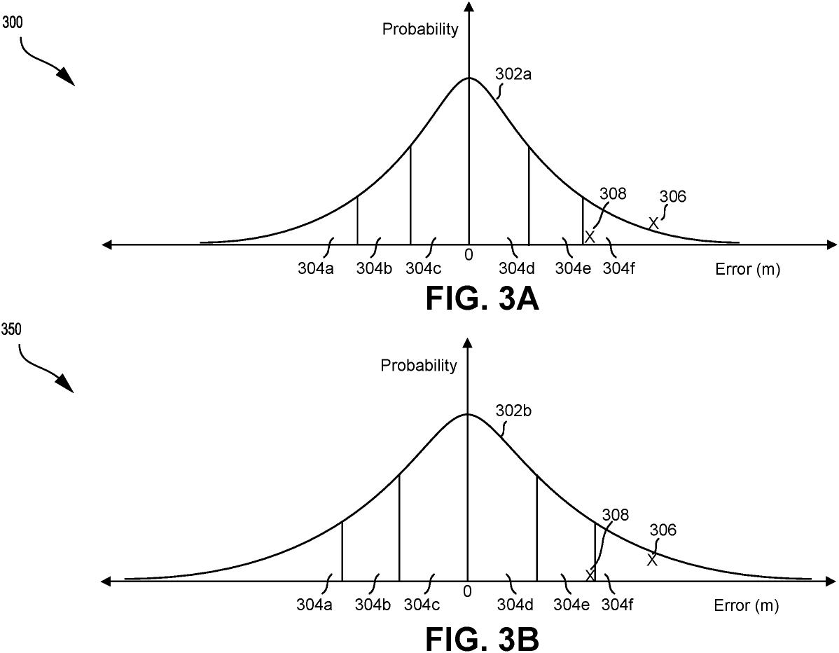

FIG. 3A illustrates a graph 300 of an uncertainty distribution 302a associated with a predicted location of an object. In some cases, the uncertainty distribution 302a can be associated with a predicted location of pedestrian 204. In some embodiments, the uncertainty distribution 302a can correspond to a distribution of the variance in a direction of movement of pedestrian 204 (e.g., up, down, left, and/or right). As illustrated, the uncertainty distribution 302a corresponds to a normal or Gaussian distribution. In some aspects, the uncertainty distribution 302a may correspond to a chi-squared distribution, a binomial distribution, a Poisson distribution, and/or any other type of suitable statistical distribution. In some examples, uncertainty distribution 302a may be divided into quantiles 304a - 304f.

In some cases, the uncertainty distribution 302a may correspond to an uncertainty metric associated with uncertainty area 208 for predicted location 205b of pedestrian 204 at time t₁. In some examples, the error 212 between the actual position 207a of pedestrian 204 at time t₁ and the predicted position 205b can be represented by error 306 that is outside of uncertainty distribution 302a. In some embodiments, the error 212 between the actual position 207a of pedestrian 204 at time t₁ and the predicted position 205b can be represented by error 308 that is within upper quantile 304f of uncertainty distribution 302a. In some aspects, the prediction stack 116 may use error 306 and/or error 308 to increase or revise uncertainty distribution 302a for future location predictions. In some cases, uncertainty distribution 302a can be increased such that error 306 is within the uncertainty distribution 302a. In some examples, uncertainty distribution 302a can be increased such that error 308 is within quantile 304e of uncertainty distribution 302a.

FIG. 3B illustrates a graph 350 of a revised uncertainty distribution 302b associated with a predicted location of an object. In some cases, revised uncertainty distribution 302b can correspond to an uncertainty metric associated with revised uncertainty area 218 for predicted location 207b of pedestrian 204 at time t₂. For example, the prediction stack 116 can use error 214 to revise or increase an uncertainty metric associated with future predicted locations of pedestrian 204. In some embodiments, revised uncertainty distribution 302b can correspond to an expanded version of uncertainty distribution 302a such that error 306 is within revised uncertainty distribution 302b. In some aspects, revised uncertainty distribution 302b can correspond to an expanded version of uncertainty distribution 302a such that error 308 is within quantile 304e (e.g., the error 308 is not in the highest quantile).

Returning to FIG. 2C, in some aspects, the prediction stack 116 of AV 102 can provide the revised uncertainty metric (e.g., revised uncertainty area 218) to the planning stack 118 of the AV 102. In some embodiments, the planning stack 118 can use revised uncertainty area 218 to determine or devise a trajectory for AV 102 to minimize risk of collision (e.g., with pedestrian 204). For example, planning stack 118 may route AV 102 around revised uncertainty area 222 at time t₃. In some cases, the planning stack 118 may cause AV 102 to stop to avoid collision with pedestrian 204 (e.g.., based on revised uncertainty area 218).

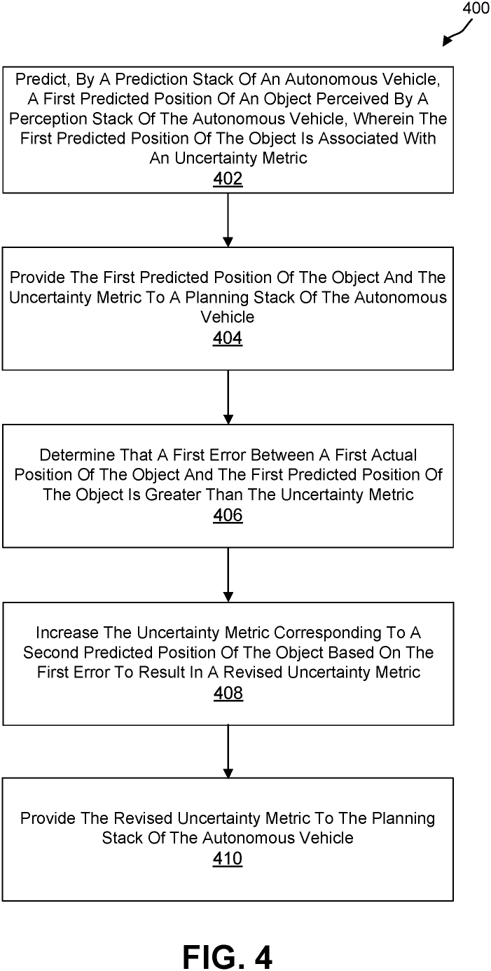

FIG. 4 illustrates an example method 400 for adjusting an uncertainty metric associated with the predicted trajectory of an object. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In some embodiments, at block 402 the method 400 includes predicting, by a prediction stack of an autonomous vehicle, a first predicted position of an object perceived by a perception stack of the autonomous vehicle. For example, prediction stack 116 of AV 102 can predict a first position of an object perceived by perception stack 112. In some cases, the method 400 can include predicting the first predicted position of the object based on sensor data received from the perception stack of the autonomous vehicle. For instance, prediction stack 116 can predict the first predicted position 205b of pedestrian 204 based on sensor data (e.g., sensor system 104-108). In some cases, the first predicted position of the object can be associated with an uncertainty metric. For example, the first predicted position 205b of pedestrian 204 can be associated with an uncertainty metric (e.g., variance in direction) corresponding to uncertainty area 208.

In some embodiments, the first predicted position can include a plurality of predicted positions corresponding to a plurality of future time intervals. For example, the first predicted position can include a plurality of successive locations along the predicted path (e.g., predicted position 205b and predicted position 205c). In some cases, the prediction stack 116 can predict a trajectory that includes a plurality of predicted positions each time it receives data from perception stack 112. In some aspects, each of the successive locations can correspond to a future time interval wherein the object is predicted to be at the successive locations at each respective future time interval.

In some examples, each subsequent predicted trajectory may include one or more predicted positions that overlap with one or more predicted positions in a prior predicted trajectory. In some cases, the plurality of predicted positions (e.g., in a predicted trajectory) can be associated with a corresponding uncertainty metric. In some aspects, the uncertainty metric can represent a range descriptive of an area of probabilistic locations around a respective successive location in which it is deemed probable for the object to be located at the time corresponding to the successive location. In some cases, the uncertainty metric may increase for each subsequent future time interval.

In some aspects, at block 404 the method 400 can include providing the first predicted position of the object and the uncertainty metric to a planning stack of the autonomous vehicle. For instance, prediction stack 116 of AV 102 can provide the first predicted position 205b of pedestrian 204 and the uncertainty metric (e.g., uncertainty area 208) to planning stack 116. In some embodiments, providing the first predicted position can include providing a plurality of predicted positions. For example, prediction stack 116 of AV 102 can provide the first predicted position 205b of pedestrian 204 as well as the second predicted position 205c of pedestrian 204. In some cases, the plurality of predicted positions can include a time series of ‘N’ predicted positions each corresponding to a future time interval (e.g., 0.5 s increments).

In some embodiments, at block 406 the method 400 can include determining that a first error between a first actual position of the object and the first predicted position of the object is greater than the uncertainty metric. For example, prediction stack 116 can determine that error 212 between first actual position 207a and first predicted position 205b is greater than the uncertainty metric (e.g., the first actual position of the object is outside the area of probabilistic locations associated with the first of the successive locations in the predicted path). In some cases, when the error is greater than the uncertainty metric the actual position of the object (e.g., pedestrian 204) is outside of an uncertainty area corresponding to the uncertainty metric.

In some cases, at block 408 the method 400 can include increasing the uncertainty metric corresponding to a second predicted position of the object based on the first error to result in a revised uncertainty metric. For instance, prediction stack 116 can increase the uncertainty metric corresponding to second predicted position 207b of pedestrian 204 based on error 212. In some aspects, increasing the uncertainty metric can result in a revised uncertainty metric that may correspond to revised uncertainty area 218. In some cases, increasing the uncertainty metric is sufficient to compensate for the first determined error.

In some examples, the method 400 can include increasing the uncertainty metric corresponding to a plurality of future predicted positions based on the first error. For example, the first error may be used to adjust the uncertainty metric corresponding to a predicted trajectory that includes a plurality of predicted positions. In some aspects, at time t₁ the prediction stack 116 can adjust the uncertainty metric corresponding to predicted positions for times t₂ through t_{N}. In some cases, at time t₂ the prediction stack 116 can adjust the uncertainty metric corresponding to predicted positions for times t₃ through t_{N+1}. In some aspects, the prediction stack 116 can make new predictions periodically (e.g., at times t1 through t_{N+1}) that each include a corresponding uncertainty metric that can be adjusted according to the previously perceived error.

In some examples, the uncertainty metric and the revised uncertainty metric include an expected error in at least one direction of movement of the object. For example, the uncertainty metric and/or the revised uncertainty metric can include variances representing the uncertainty in each of four directions of movement of pedestrian 204 (e.g., up, down, left, and right). In some cases, the expected error can correspond to a distribution. For example, the first error can correspond to a normal distribution (e.g., uncertainty distribution 302a). In some cases, the distribution can correspond to a chi-squared distribution, half-normal distribution, and/or any other suitable statistical distribution.

In some embodiments, to determine that the first error is greater than the uncertainty metric the method 400 can include determining that the first error is outside a last quantile of the distribution. For instance, prediction stack 116 can determine that error 306 is outside of quantile 304f of uncertainty distribution 302a. In some aspects, to increase the second uncertainty metric the method 400 can include increasing a range of the distribution to include the first error within a last quantile of the distribution. For instance, revised uncertainty distribution 302b can be increased such that error 306 is within quantile 304f.

In some aspects, at block 410 the method 400 can include providing the revised uncertainty metric to the planning stack of the autonomous vehicle. For example, prediction stack 116 can provide the revised uncertainty metric (e.g., revised uncertainty area 218) to planning stack 118 of AV 102.

In some embodiments, the method 400 may include determining that a second error between a second actual position of the object and the second predicted position of the object is less than the revised uncertainty metric. For example, prediction stack 116 can determine that an error associated with an actual position at time t₂ and predicted position 207b is less than revised uncertainty area 218. In some aspects, the method 400 may include decreasing the revised uncertainty metric corresponding to a third predicted position of the object based on the second error. For example, prediction stack 116 may decrease the revised uncertainty area 222 associated with predicted position 207c at time t₃ to uncertainty area 220.

In some aspects, the first predicted position and the uncertainty metric can be based on a machine learning algorithm implemented by the prediction stack of the autonomous vehicle. For instance, prediction stack 116 of AV 102 can implement a machine learning algorithm that can be used to determine the first predicted position 205b and the uncertainty metric (e.g., uncertainty area 208).

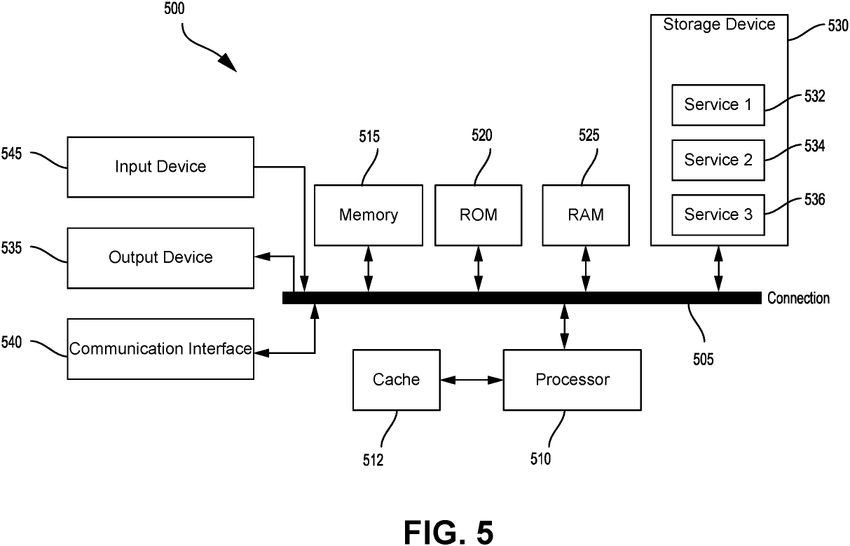

FIG. 5 shows an example of computing system 500, which can be for example any computing device making up autonomous vehicle 102 or remote computing system 150, or any component of autonomous vehicle 102 or remote computing system 150 in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Some examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

Illustrative aspects of the disclosure include:

Aspect 1. A method comprising: predicting, by a prediction stack of an autonomous vehicle, a first predicted position of an object perceived by a perception stack of the autonomous vehicle, wherein the first predicted position of the object is associated with an uncertainty metric; providing the first predicted position of the object and the uncertainty metric to a planning stack of the autonomous vehicle; determining that a first error between a first actual position of the object and the first predicted position of the object is greater than the uncertainty metric; increasing the uncertainty metric corresponding to a second predicted position of the object based on the first error to result in a revised uncertainty metric; and providing the revised uncertainty metric to the planning stack of the autonomous vehicle.

Aspect 2. The method of Aspect 1, further comprising: determining that a second error between a second actual position of the object and the second predicted position of the object is less than the revised uncertainty metric; and decreasing the revised uncertainty metric corresponding to a third predicted position of the object based on the second error.

Aspect 3. The method of any of Aspects 1 to 2, wherein the uncertainty metric and the revised uncertainty metric include an expected error in at least one direction of movement of the object.

Aspect 4. The method of Aspect 3, wherein the expected error corresponds to a distribution.

Aspect 5. The method of Aspect 4, wherein determining that the first error is greater than the uncertainty metric comprises: determining that the first error is outside a last quantile of the distribution.

Aspect 6. The method of any of Aspects 4 to 5, wherein increasing the second uncertainty metric comprises: increasing a range of the distribution to include the first error within a last quantile of the distribution.

Aspect 7. The method of any of Aspects 1 to 6, further comprising: predicting the first predicted position of the object based on sensor data received from the perception stack of the autonomous vehicle.

Aspect 8. The method of any of Aspects 1 to 7, wherein the first predicted position includes a plurality of predicted positions corresponding to a plurality of future time intervals.

Aspect 9. The method of Aspect 8, wherein each of the plurality of predicted positions are associated with a corresponding uncertainty metric.

Aspect 10. The method of any of Aspects 1 to 9, wherein the first predicted position and the uncertainty metric are based on a machine learning algorithm implemented by the prediction stack of the autonomous vehicle.

Aspect 11. An autonomous vehicle (AV) comprising: at least one memory; and at least one processor coupled to the at least one memory, wherein the at least one processor is configured to: predict a first predicted position of an object perceived by one or more sensors of the autonomous vehicle, wherein the first predicted position of the object is associated with an uncertainty metric; determine that a first error between a first actual position of the object and the first predicted position of the object is greater than the uncertainty metric; increase the uncertainty metric corresponding to a second predicted position of the object based on the first error to result in a revised uncertainty metric; and provide the revised uncertainty metric to a planning stack for maneuvering the autonomous vehicle.

Aspect 12. The AV of Aspect 11, wherein the at least one processor is further configured to: determine that a second error between a second actual position of the object and the second predicted position of the object is less than the revised uncertainty metric; and decrease the revised uncertainty metric corresponding to a third predicted position of the object based on the second error.

Aspect 13. The AV of any of Aspects 11 to 12, wherein the uncertainty metric and the revised uncertainty metric include an expected error in at least one direction of movement of the object.

Aspect 14. The AV of any of Aspects 11 to 13, wherein to determine that the first error is greater than the uncertainty metric the at least one processor is further configured to: determine that the first error is outside a last quantile of a distribution associated with the uncertainty metric.

Aspect 15. The AV of Aspect 14, wherein to increase the second uncertainty metric the at least one processor is further configured to: increase a range of the distribution to include the first error within a last quantile of the distribution.

Aspect 16. A non-transitory computer-readable storage medium having stored thereon instructions which, when executed by one or more processors, cause the one or more processors to: predict a first predicted position of an object perceived by a perception stack of an autonomous vehicle, wherein the first predicted position of the object is associated with an uncertainty metric; provide the first predicted position of the object and the uncertainty metric to a planning stack of the autonomous vehicle; determine that a first error between a first actual position of the object and the first predicted position of the object is greater than the uncertainty metric; increase the uncertainty metric corresponding to a second predicted position of the object based on the first error to result in a revised uncertainty metric; and provide the revised uncertainty metric to the planning stack of the autonomous vehicle.

Aspect 17. The non-transitory computer-readable storage medium of Aspect 16, comprising additional instructions which, when executed by one or more processors, cause the one or more processors to: determine that a second error between a second actual position of the object and the second predicted position of the object is less than the revised uncertainty metric; and decrease the revised uncertainty metric corresponding to a third predicted position of the object based on the second error.

Aspect 18. The non-transitory computer-readable storage medium of any of Aspects 16 to 17, wherein the uncertainty metric and the revised uncertainty metric include an expected error in at least one direction of movement of the object.

Aspect 19. The non-transitory computer-readable storage medium of any of Aspects 16 to 18, comprising additional instructions which, when executed by one or more processors, cause the one or more processors to: determine that the first error is outside a last quantile of a distribution associated with the uncertainty metric.

Aspect 20. The non-transitory computer-readable storage medium of Aspect 19, comprising additional instructions which, when executed by one or more processors, cause the one or more processors to: increasing a range of the distribution to include the first error within a last quantile of the distribution.

Aspect 21. A method comprising: predicting, by a prediction stack of an autonomous vehicle, predicted path of an object perceived by a perception stack of the autonomous vehicle, wherein the predicted path of the object includes a plurality of successive locations along the predicted path, wherein each of the successive locations corresponding to a future time interval wherein the object is predicted to be at the successive locations at each respective future time interval, wherein each of the successive locations is associated with a respective uncertainty metric, the uncertainty metric representing an range descriptive of an area of probabilistic locations around a respective successive location in which it is deemed probably for the object to be located at the time corresponding to the successive location, a first of the successive locations being the predicted location of the object at a first time; providing the predicted path including the successive location and their respective uncertainty metric to a planning stack of the autonomous vehicle; after the first time, determining a first error representing a first actual position of the object as being outside the area of probabilistic locations associated with the first of the successive locations as indicated by the uncertainty metric associated with the first of the successive locations; after the first time, increasing the uncertainty metric corresponding to the respective the successive locations for the successive locations that still correspond to a future time interval, wherein the increased uncertainty metric is sufficient to compensate for the determined first error, wherein the increasing of the uncertainty metric results in a revised uncertainty metric; and providing the revised uncertainty metric corresponding to the respective the successive locations for the successive locations that still correspond to a future time interval to the planning stack of the autonomous vehicle.

What is claimed is:

1. A method comprising:
predicting, by a prediction stack of an autonomous vehicle, a first predicted position of an object perceived by a perception stack of the autonomous vehicle, wherein the first predicted position of the object is associated with an uncertainty metric;
providing the first predicted position of the object and the uncertainty metric to a planning stack of the autonomous vehicle;
determining that a first error between a first actual position of the object and the first predicted position of the object is greater than the uncertainty metric;
increasing the uncertainty metric corresponding to a second predicted position of the object based on the first error to result in a revised uncertainty metric; and
providing the revised uncertainty metric to the planning stack of the autonomous vehicle.

2. The method of claim 1, further comprising:
determining that a second error between a second actual position of the object and the second predicted position of the object is less than the revised uncertainty metric; and
decreasing the revised uncertainty metric corresponding to a third predicted position of the object based on the second error.

3. The method of claim 1, wherein the uncertainty metric and the revised uncertainty metric include an expected error in at least one direction of movement of the object.

4. The method of claim 3, wherein the expected error corresponds to a distribution.

5. The method of claim 4, wherein determining that the first error is greater than the uncertainty metric comprises:
determining that the first error is outside a last quantile of the distribution.

6. The method of claim 4, wherein increasing the second uncertainty metric comprises:
increasing a range of the distribution to include the first error within a last quantile of the distribution.

7. The method of claim 1, further comprising:
predicting the first predicted position of the object based on sensor data received from the perception stack of the autonomous vehicle.

8. The method of claim 1, wherein the first predicted position includes a plurality of predicted positions corresponding to a plurality of future time intervals.

9. The method of claim 8, wherein each of the plurality of predicted positions are associated with a corresponding uncertainty metric.

10. The method of claim 1, wherein the first predicted position and the uncertainty metric are based on a machine learning algorithm implemented by the prediction stack of the autonomous vehicle.

11. An autonomous vehicle (AV) comprising:
at least one memory; and
at least one processor coupled to the at least one memory, wherein the at least one processor is configured to:
predict a first predicted position of an object perceived by one or more sensors of the autonomous vehicle, wherein the first predicted position of the object is associated with an uncertainty metric;
determine that a first error between a first actual position of the object and the first predicted position of the object is greater than the uncertainty metric;
increase the uncertainty metric corresponding to a second predicted position of the object based on the first error to result in a revised uncertainty metric; and
provide the revised uncertainty metric to a planning stack for maneuvering the autonomous vehicle.

12. The AV of claim 11, wherein the at least one processor is further configured to:
determine that a second error between a second actual position of the object and the second predicted position of the object is less than the revised uncertainty metric; and
decrease the revised uncertainty metric corresponding to a third predicted position of the object based on the second error.

13. The AV of claim 11, wherein the uncertainty metric and the revised uncertainty metric include an expected error in at least one direction of movement of the object.

14. The AV of claim 11, wherein to determine that the first error is greater than the uncertainty metric the at least one processor is further configured to:
determine that the first error is outside a last quantile of a distribution associated with the uncertainty metric.

15. The AV of claim 14, wherein to increase the second uncertainty metric the at least one processor is further configured to:
increase a range of the distribution to include the first error within a last quantile of the distribution.

16. A non-transitory computer-readable storage medium having stored thereon instructions which, when executed by one or more processors, cause the one or more processors to:
predict a first predicted position of an object perceived by a perception stack of an autonomous vehicle, wherein the first predicted position of the object is associated with an uncertainty metric;
provide the first predicted position of the object and the uncertainty metric to a planning stack of the autonomous vehicle;
determine that a first error between a first actual position of the object and the first predicted position of the object is greater than the uncertainty metric;
increase the uncertainty metric corresponding to a second predicted position of the object based on the first error to result in a revised uncertainty metric; and
provide the revised uncertainty metric to the planning stack of the autonomous vehicle.

17. The non-transitory computer-readable storage medium of claim 16, comprising additional instructions which, when executed by one or more processors, cause the one or more processors to:
determine that a second error between a second actual position of the object and the second predicted position of the object is less than the revised uncertainty metric; and
decrease the revised uncertainty metric corresponding to a third predicted position of the object based on the second error.

18. The non-transitory computer-readable storage medium of claim 16, wherein the uncertainty metric and the revised uncertainty metric include an expected error in at least one direction of movement of the object.

19. The non-transitory computer-readable storage medium of claim 16, comprising additional instructions which, when executed by one or more processors, cause the one or more processors to:
determine that the first error is outside a last quantile of a distribution associated with the uncertainty metric.

20. The non-transitory computer-readable storage medium of claim 19, comprising additional instructions which, when executed by one or more processors, cause the one or more processors to:
increasing a range of the distribution to include the first error within a last quantile of the distribution.
